(19) United States
(12) Patent Application Publication
(10) Pub. No.: US 2002/0197441 A1
(43) Pub. Date: Dec. 26, 2002

(54) Storage medium for data

(76) Inventors: Ramesh Hariharan, Malden, MA (US); Thomas Paul Feist, Clifton Park, NY (US); Grant Hay, Niskayuna, NY (US); Kathryn Lynn Longley, Saratoga Springs, NY (US); Wit Cezary Bushko, Niskayuna, NY (US); Irene Dris, Clifton Park, NY (US); Azar Alizadeh, Saratoga Springs, NY (US)

Correspondence Address: GENERAL ELECTRIC COMPANY, GLOBAL RESEARCH CENTER, PATENT DOCKET RM. 4A59, PO BOX 8, BLDG. K-1 ROSS, NISKAYUNA, NY, 12309, US

(21) Appl. No.: 09/943,767

(22) Filed: Aug. 31, 2001

Related U.S. Application Data
(60) Provisional application No. 60/279,887, filed on Mar. 29, 2001.

(51) Int. Cl. G11B 7/24; C08F 12/08; C08F 112/02; C08F 120/18; C08G 64/00; C08G 69/08; C08G 73/10

(52) U.S. Cl. 428/65.1; 428/64.7; 430/270.11; 369/288; 528/310; 528/196; 526/319; 526/329.7; 526/346

(57) ABSTRACT

A method for determining the water strain of an article is provided in the present invention by predetermining a maximum tilt range and radius for the article. Further embodiments of the present invention include a storage medium for data and a polymer for use in a storage medium for data where the storage medium comprises a plurality of layers wherein the aforementioned water strain is calculated for the plurality of layers.

### CROSS-REFERENCE TO RELATED APPLICATIONS

This application claims priority to Provisional Application No. 60/279,887 entitled “Radial Tilt Reduced Media,” filed on Mar. 29, 2001 which is incorporated herein by reference.

### BACKGROUND OF THE INVENTION

The present invention relates to polymers for storage medium applications. More particularly, the present invention relates to decreasing tilt of a storage medium via determination of the water strain of a polymer.

Improvements in optical data storage media, including increased data storage density, are highly desirable and achievement of such improvements is expected to improve well-established and new computer technology such as read-only, write-once, rewritable, digital versatile and magneto-optical (MO) disks.

As data storage densities are increased in optical data storage media to accommodate newer technologies, such as digital versatile disks (DVD) and higher density data disks for short or long term data archives such as digital video recorders (DVR), the design requirements for the transparent plastic component of the optical data storage devices have become increasingly stringent. Optical disks with progressively shorter “reading and writing” wavelengths have been the object of intense efforts in the field of optical data storage devices.

The design requirements for the material used in optical data storage media include low water strain/absorption, low birefringence, high transparency, heat resistance, ductility, high purity and few inhomogeneities or particulates. Currently employed materials are found to be lacking in one or more of these characteristics, and new materials are required in order to achieve higher data storage densities in optical data storage media.

In applications requiring higher storage density, the property of water absorption in the polymer material from which the optical article is fabricated becomes even more critical. Upon absorption of water a subsequent volume change in the material occurs. The linear strain of the material due to water absorption is denoted as water strain. In order to achieve higher data storage density, water strain is a physical property that affects tilt or disk flatness in the optical article. Disk flatness is a critical property needed for high data storage density applications. It is known that excessive water strain results in disk skewing which in turn leads to reduced reliability. Since the bulk of the disk is comprised of the polymer material, the flatness of the disk depends on the low water strain of the polymeric material.

There exists a need for compositions having disk flatness. Materials and methods for optimizing physical properties are constantly being sought which are suitable for use in storage media for data.

### BRIEF SUMMARY OF THE INVENTION

In one embodiment, the present invention provides a storage medium for data comprising a plurality of layers comprising:

a) a substrate layer comprising a polymer; and

b) at least one data layer on the substrate;

wherein the polymer at a predetermined maximum tilt range for the storage medium has a water strain determined by the following equation (I):

$$Water Strain ( \% ) < \frac{Max Radial Tilt Range ( degrees ) \cdot t \cdot π}{3.46 Δ rh \cdot r .}$$

wherein t is substrate thickness; r is a predetermined radius of the storage medium; and Δrh is change in relative humidity.

In another embodiment, the present invention further provides a storage medium for data comprising a plurality of layers comprising:

a) at least one substrate layer comprising a polymer,

b) at least one data layer on the substrate; and

c) at least one thin film layer on the data layer wherein the thin film layer comprises a material with substantially the same physical properties as the polymer; and

wherein the polymer at a predetermined maximum tilt range for the storage medium has a water strain determined by the following equation (II):

$$Water Strain ( \% ) < \frac{Max Radial Tilt Range ( degrees ) \cdot t \cdot π}{3.46 Δ rh \cdot r ( 11.474 {ρ}^{2} - 6.6 ρ + 0.99 )}$$

wherein t is substrate thickness; ρ is a predetermined thickness ratio of the thickness of the thin film layer to the thickness of the substrate layer; r is a predetermined radius of the storage medium; and Δrh is change in relative humidity.

In yet a further embodiment of the present invention, there is provided a method for determining the water strain of a multilayer article with water absorption from one side, the method comprising predetermining a maximum tilt range and radius for the article; and

calculating the water strain using equation (I).

In yet a further embodiment of the present invention, there is provided a method for determining the water strain of a multilayer article with water absorption from more than one side, the method comprising predetermining a maximum tilt range and radius for the article; and

calculating the water strain using equation (H).

In yet a further embodiment of the present invention, there is provided a polymer for the use in a storage medium for data wherein the storage medium comprises

a) a substrate layer comprising the polymer; and

b) at least one data layer;

wherein the polymer at a predetermined maximum tilt range for the storage medium has a water strain determined by equation (I).

In yet a further embodiment of the present invention, there is provided a polymer for the use in a storage medium for data wherein the storage medium comprises

a) at least one substrate layer comprising the polymer,

b) at least one data layer on the substrate; and

c) at least one thin film layer on the data layer wherein the thin film layer comprises substantially the a material with substantially the same physical properties as the polymer; and

wherein the polymer at a predetermined maximum tilt range for the storage medium has a water strain determined by equation (II).

### BRIEF DESCRIPTION OF THE DRAWINGS

FIG. 1 outlines the reduction in system tilt for a matched system as a function of film thickness.

FIG. 2 depicts the change in radial tilt at 53 mm for a 2,2-bis(4-hydroxyphenyl)propane (BPA-PC) substrate with a BPA-PC film.

### DETAILED DESCRIPTION OF THE INVENTION

In this specification and in the claims that follow, reference will be made to a number of terms that shall be defined to have the following meaning.

The singular forms “a”, “an” and “the” include plural referents unless the context clearly dictates otherwise.

“Optional” or “optionally” mean that the subsequently described event or circumstance may or may not occur, and that the description includes instances where said event or circumstance occurs and instances where it does not.

The present invention is based on the use of polymers for a storage medium for data. In one embodiment of the present invention, the storage medium for data comprises a plurality of layers which comprise a substrate portion and at least one data layer on the substrate. In yet another embodiment of the present invention, the storage medium for data comprises a plurality of layers which comprise at least one substrate portion, at least one data layer on the substrate, and at least one thin film layer on the data layer.

The data storage layer may comprise any material capable of storing retrievable data, such as an optical layer, magnetic layer, or more preferably, a magneto-optic layer, having a thickness of up to about 600 Angstroms (Å), with a thickness up to about 300 Å preferred. This information may be imprinted directly onto the surface, or stored in a photo-, thermal-, or magnetically-definable medium which has been deposited onto the surface of the substrate. Possible data storage layers include, but are not limited to, oxides (such as silicone oxide), rare earth element-transition metal alloys, nickel, cobalt, chromium, tantalum, platinum, terbium, gadolinium, iron, boron, others, and alloys and combinations comprising at least one of the foregoing, organic dyes (e.g., cyanine or phthalocyanine type dyes), and inorganic phase change compounds (e.g., TeSeSn or InAgSb). Typically, the data layer has a coercivity of at least about 1,500 oersted, with a coercivity of about 3,000 oersted or greater especially preferred.

Other layers which may be applied to the substrate may include one or more dielectric layer(s), insulating layer(s), adhesive layer(s), combinations comprising at least one of these layers and others. The dielectric layer(s) which are often employed as heat controllers can typically have a thickness of up to or exceeding about 1,000 Å and as low as about 200 Å. Possible dielectric layers include nitrides (e.g., silicone nitride, aluminum nitride, and others); oxides (e.g. aluminum oxide); carbides (e.g., silicon carbide); and combinations comprising at least one of the foregoing, among other materials compatible within the environment and preferably, not reactive with the surrounding layers.

The reflective layer(s) should have a sufficient thickness to reflect a sufficient amount of energy to enable data retrieval. Typically, the reflective layer(s) can have a thickness of up to about 700 Å, with a thickness in a range between about 300 Å and about 600 Å generally preferred. Possible reflective layers include any material capable of reflecting the particular energy field, including metals (e.g., aluminum, silver, gold, titanium, and alloys and mixtures comprising at least one of the foregoing, and others).

The adhesive layer is typically used to adhere the read-through thin film to the other layers supported by the substrate. Typical adhesives are rubber-based or rubber-like materials, such as natural rubber or silicone rubber or acrylic ester polymers, and the like. Non-rigid polymeric adhesives such as those based on rubber or acrylic polymers and the like have some of the properties of elastomers, such as flexibility, creep resistance, resilience, and elasticity, and provide useful dampening to enhance the quality of playback of the data storage disk. The chemistry of non-rigid polymeric adhesives is diverse, and includes polymers of the types of materials described herein as elastomers and rubbers, as flexible thermoplastics, and as thermoplastic elastomers. Suitable examples of such polymeric materials which may be used in the adhesive layer are polyisoprene, styrene butadiene rubber, ethylene propylene rubber, fluoro vinyl methyl siloxane, chlorinated isobutene-isoprene, chloroprene, chlorinated polyethylene, chlorosulfonated polyethylene, butyl acrylate, expanded polystyrene, expanded polyethylene, expanded polypropylene, foamed polyurethane, plasticized polyvinyl chloride, dimethyl silicone polymers, methyl vinyl silicone, polyvinyl acetate and the like. The adhesive layer may be added to the data storage medium by conventional methods such as, for example, spin coating, solution deposition, injection molding, extrusion molding, and the like. Typically, pressure sensitive adhesives are preferred for use in such applications. In addition to the data storage layer(s), dielectric layer(s), protective layer(s), adhesive layer(s), and reflective layer(s), other layers can be employed such as lubrication layer(s) and others. Useful lubricants include fluoro compounds, for example fluoro oils and greases, and the like.

The film for these high density formats have optical properties such as in-plane retardations of 10 nanometers (nm) and lower for these films. The films also have low thickness non-uniformity and surface roughness. For a 100 micron film, thickness uniformity at length scales longer than 2 centimeters (cm) is on the order of less than 2 microns and the surface roughness at the 1 millimeter (mm) length scale is on the order of 40 nm or less. The common processes that are utilized to produce film with these specifications are, for example, solution casting, extrusion casting, extrusion calendaring, spin coating, and injection molding. Preferably, solution casting is used.

Numerous methods may be employed to produce the storage medium including, but not limited to, injection molding, foaming processes, sputtering, plasma vapor deposition, vacuum deposition, electrodeposition, spin coating, spray coating, meniscus coating, data stamping, embossing, surface polishing, fixturing, laminating, rotary molding, two shot molding, coinjection, over-molding of film, microcellular molding, and combinations thereof. Preferably, the technique employed enables in situ production of the substrate having the desired features, for example, pits and grooves. One such process comprises an injection molding-compression technique where a mold is filled with a molten polymer as defined herein. The mold may contain a preform, insert, etc. The polymer system is cooled and, while still in at least partially molten state, compressed to imprint the desired surface features, for example, pits and grooves, arranged in spiral concentric or other orientation, onto the desired portions of the substrate, i.e., one or both sides in the desired areas. The substrate is then cooled to room temperature.

Generally, in high areal density applications, i.e. about 5 Gigabits per square inch (Gbits/in²) or greater, the read/write device is located relatively close to the surface of the storage medium (stand-off distance). In general, the higher the density sought, the closer the read/write device should be to the surface of the storage medium. Typically in these instances, the stand-off distance is generally less than about 0.3 millimeters (mm), and often less than about 760 nanometers (nm). For extremely high density, the read/write device is preferably extremely close, e.g., less than about 0.064 microns (μ), often less than about 0.013 μfrom the surface. Systems of the present invention for reading data typically operate in a frequency range between about 1 Hz and about 500 Hz, and preferably in a range between about 100 Hz and about 200 Hz. To attain high areal densities in optical storage media the beam spot diameter needs to be decreased. In a pure diffraction limited case, the beam diameter is related to the numerical aperture and wavelength in the following way:

$$Beam Spot Diameter ∝ [ \frac{λ}{NA} ]$$

where λ=wavelength of light source and NA=numerical aperture of objective lens.

Usually both laser wavelength and numerical aperture is altered to achieve the density increase needed. This has an impact on the tilt tolerance of a disk. “Tilt” as used herein refers to the degrees by which a material bends on a horizontal axis and is typically measured as the vertical deviation at the outer radius of the storage medium. Typically, the tilt is determined by measuring the deflection of a laser beam incident at some angle to the disk. From geometrical considerations the deflection of the laser beam is equal to two times the radial tilt angle. This is denoted as the radial deviation and is two times the tilt angle measured in degrees. Tilt tolerance is related to the numerical aperture and wavelength in the following way:

$$Tilt Margin ∝ [ \frac{λ}{d \cdot {NA}^{3}} ]$$

where d=thickness of read-through medium.

When the storage medium comprises at least one substrate layer and at least one data layer, asymmetry in water absorption is typically caused by the near to zero permeability of water through the data layer (i.e., a sputtered metallic and organic/inorganic layers). Assuming the storage medium structure is an elastic plate that extends infinitely in the in-plane directions and that the material properties are not a function of thickness, then the isotropic strain due to water absorption is given by the below expression:

$$\overline{ϵ} ( t ) = \frac{β}{l} {\int }_{l / 2}^{- l / 2} c ( z , t ) ⅆ z$$

where ε=strain; z=thickness direction; 1=thickness; c=concentration; and β=swell coefficient where ε(t)=βc(z,t).

The curvature of the substrate is related to the first moment of the water distribution in the disk as shown below:

$$κ ( t ) = \frac{12 β}{l} {\int }_{l / 2}^{- l / 2} c ( z , t ) z ⅆ z$$

and the concentration of water as a function of thickness and time c(z,t) is calculated from a solution to the diffusion equation.

For the multilayer article with water absorption from one side (due to the impermeability of water on the opposite side), the maximum of the radial tilt range due to water absorption at a given temperature (T) is given by the below expression:

$$Max Radial Tilt Range ( rad ) = κ r = \frac{1.92 Δ rh β sr}{t} = \frac{1.92 Δ rh ϵ r}{t}$$

where κ is the curvature (length⁻¹); Δrh is step relative humidity; β is strain/mass fraction water at a given temperature(T); s is mass fraction water at relative humidity (rh)=1 and T;ε=βs is water strain at rh=1 and T; t is substrate thickness; and r is radius of interest. The “maximum radial tilt range” as used herein is the disk curvature during absorption and subsequent desorption of water and is hence twice the radial tilt specification as usually specified by the developers in the industry.

For the multilayer article with water absorption from one side with a given maximum radial tilt specification in degrees at a specific radius and a given substrate thickness, the material water strain needs to meet the following condition of equation (I):

$$0 > Water Strain ( \% ) < \frac{Max Radial Tilt Range ( degrees ) \cdot t \cdot π}{3.46 Δ rh \cdot r}$$

For the multilayer article of a given material with water absorption from one side and a given maximum radial tilt specification in degrees at a specific radius, the thickness of the substrate needs meet the following condition:

$$Substrate Thickness > \frac{3.46 \cdot Δ rh \cdot water strain ( \% ) \cdot r}{Max Radial Tilt Range ( degrees ) \cdot π}$$

For a multilayer article with water absorption from more than one side (for example, a storage medium that includes at least one substrate layer, at least one data layer on the substrate layer, and at least one thin film layer), the integral of the curvature of the substrate is split into a summation of integrals for each specific layer thickness including material parameters for each layer. The resulting analytical solution is given below in general form:

$$Max Radial Tilt ( rad ) = κ r = \frac{Δ rh β s}{{ρ}_{2}} f ( t , \frac{{ρ}_{1}}{{ρ}_{2}} , \frac{{γ}_{1}}{{γ}_{2}} , \frac{{δ}_{1}}{{δ}_{2}} , \frac{{q}_{1}}{{q}_{2}} ) r$$

where t=substrate thickness; ρ=thickness; γ=stiffness; δ=strain; and q=diffusivity (wherein subscript 1 denotes the thin film layer; and subscript 2 denotes the substrate layer).

When the storage medium includes at least one substrate layer, at least one data layer on the substrate layer, and at least one thin film layer, the impermeable layer is at the interface between the substrate layer and the thin film layer. The impermeable layer is sufficiently impermeable to water absorption. “Sufficiently impermeable” as used here refers to water absorption that does not have a measurable effect on the dimensional stability of the storage medium. In the present invention, the substrate layer and the thin film layer are constructed from material with substantially the same physical properties such that the ratios of the film to substrate properties as defined above are equal to about one. Other properties of interest are the coefficients of thermal expansion (CTE) and thermal conductivity. Therefore for any environmental temperature change, the film and substrate CTE and thermal conductivity ratios of a flat disk are about one.

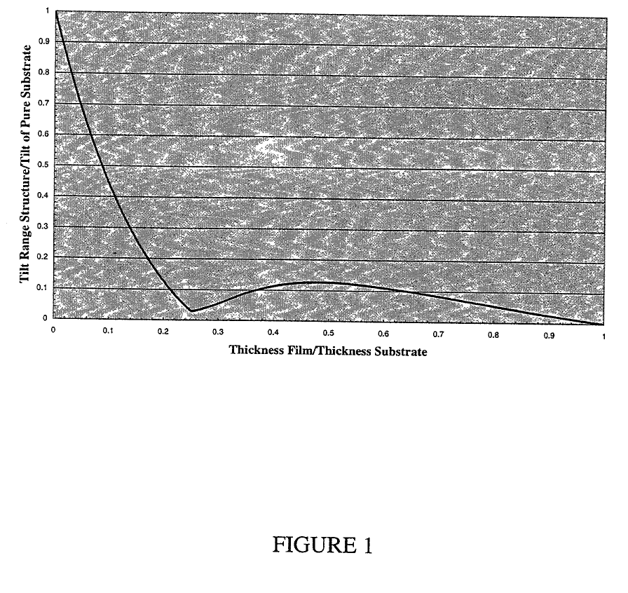

Adding a film of substantially the same material as the substrate (i.e. matched) to the storage medium results in the maximum dynamic tilt of the storage medium structure being less than that of the pure substrate. For a given thickness of film the dual layer system tilt can be normalized by the pure substrate tilt for a given matched material system. FIG. 1 outlines the reduction in system tilt for a matched system as a function of film thickness. The tilt can be minimized by selecting a film to substrate ratio that falls in a range between about 0.22 and about 0.3. The initial part of this curve can be represented by the following function between film to substrate thickness ratios in a range between 0 and about 0.22:

Tilt Range Structure/Tile of Substrate=11.474ρ²−6.6ρ+0.99

where in ρ is a predetermined thickness ratio of the thickness of the thin film layer to the thickness of the substrate layer.

Hence the Maximum radial tilt range for a two-layer structure is given by the following expression for thickness ratios in a range between 0 and about 0.22:

$$Maximum Radial Tilt Range = \frac{180 \times 1.92 Δ rh ϵ r}{t π} ( 11.474 {ρ}^{2} - 6.6 ρ + 0.99 )$$

For a storage medium structure with a given substrate portion thickness, film thickness and step humidity change, the tilt should be kept within a certain specification such that the material water strain falls within certain limits. The range of material water strain can be determined using the following equation (II):

$$Water Strain ( \% ) < \frac{Max Radial Tilt Range ( degrees ) \cdot t \cdot π}{3.46 Δ rh \cdot r ( 11.474 {ρ}^{2} - 6.6 ρ + 0.99 )}$$

wherein t, ρ, r, and Δrh are defined above.

The storage medium described herein can be employed in conventional optic, magneto-optic, and magnetic systems, as well as in advanced systems requiring higher quality storage medium, areal density, or combinations thereof. During use, the storage medium is disposed in relation to a read/write device such that energy (for instance, magnetic, light, electric, or a combination) contacts the data storage layer in the form of an energy field incident on the storage medium. The energy field contacts the layer(s) disposed on the storage medium. The energy field causes some physical change, chemical change, or combination thereof in the storage medium so as to record the incidence of the energy at that point on the layer. For example, an incident magnetic field might change the orientation of magnetic domains within the layer or an incident light beam could cause a phase transformation where the light heats the material.

Currently, the dimensions of the storage medium are specified by the industry to enable their use in presently available storage medium reading/writing devices. The storage medium typically has an inner diameter in a range between-about 15 mm and about 40 mm and an outer diameter in a range between about 65 mm and about 130 mm generally employed with a radius of 53 mm generally preferred, a substrate thickness in a range between about 0.4 mm and about 2.5 mm with a thickness up to about 1.2 mm typically preferred. Typically, for a storage medium with a substrate layer and at least one data layer, the substrate thickness is 1.2 mm with a maximum tilt range of 1.2 degrees and a maximum water strain less than 0.06%, more typically, with a maximum tilt range of 0.8 degrees and a maximum water strain less than 0.04%, and most typically, with a maximum tilt range of 0.3 degrees and a maximum water strain less than 0.015%. Optionally, the substrate thickness is 0.6 mm with a maximum tilt range of 1.2 degrees and a maximum water strain less than 0.03%, more typically, with a maximum tilt range of 0.8 degrees and a maximum water strain less than 0.02%, and most typically, with a maximum tilt range of 0.3 degrees and a maximum water strain less than 0.0008%. Typically, for a storage medium with at least one substrate layer, at least one data layer, and at least one thin film layer, the substrate thickness is 1.1 mm with a thickness ratio of 0.068, a maximum tilt range of 1.2 degrees, and a maximum water strain less than 0.095%, more typically, a maximum tilt range of 0.8 degrees and a maximum water strain less than 0.064%, and most typically, a maximum tilt range of 0.3 degrees and a maximum water strain less than 0.024. Optionally, the substrate thickness is 1.1 mm with a thickness ratio of 0.091, a maximum tilt range of 1.2 degrees, and a maximum water strain less than 0.117% more typically, a maximum tilt range of 0.8 degrees and a maximum water strain less than 0.078%, and most typically, a maximum tilt range of 0.3 degrees and a maximum water strain less than 0.029%. Other diameters and thickness may be employed to obtain more robust architecture to water induced tilt if necessary.

The major constituent of the storage medium is at least one thermoplastic polymer or thermoset polymer. Both addition and condensation polymers are included in the present invention. Illustrative, non-limiting examples of thermoplastic polymers are olefin-derived polymers such as polyethylene, polypropylene, and their copolymers; polymethylpentane; diene-derived polymers such as polybutadiene, polyisoprene, and their copolymers; polymers of ethylenically unsaturated carboxylic acids and their functional derivatives, including acrylic polymers such as poly(alkyl acrylates), poly(alkyl methacrylates), polyacrylamides, polyacrylonitrile and polyacrylic acid; alkenylaromatic polymers such as polystyrene, poly-alpha-methylstyrene, polyvinyltoluene, and rubber-modified polystyrenes; polyamides such as nylon-6, nylon-66, nylon-11, and nylon-12; polyesters; polycarbonates; polyestercarbonates; polyethers such as polyarylene ethers, polyethersulfones, polyetherketones, polyetheretherketones, and polyetherimides; polyarylene sulfides, polysulfones, and polysulfidesulfones; and liquid crystalline polymers.

Both thermoplastic polyesters and thermoplastic elastomeric polyesters are suitable for use in the present invention. Illustrative, non-limiting examples of thermoplastic polyesters include poly(ethylene terephthalate), poly(1,4-butylene terephthalate), poly(1,3-propylene terephthalate), poly(cyclohexanedimethanol terephthalate), poly(cyclohexanedimethanol-co-ethylene terephthalate), poly(ethylene naphthalate), poly(butylene naphthalate), and polyarylates. Illustrative, non-limiting examples of thermoplastic elastomeric polyesters (commonly known as TPE) include polyetheresters such as poly(alkylene terephthalate)s (particularly poly[ethylene terephthalate and poly[butylene terephthalate]) containing soft-block segments of poly(alkylene oxide), particularly segments of poly(ethylene oxide) and poly(butylene oxide); and polyesteramides such as those synthesized by the condensation of an aromatic diisocyanate with dicarboxylic acids and a carboxylic acid-terminated polyester or polyether prepolymer.

Suitable polyarylates include, but are not limited to, the polyphthalate esters of 2,2-bis(4-hydroxyphenyl)propane (commonly known as bisphenol A), and polyesters consisting of structural units of the formula I:

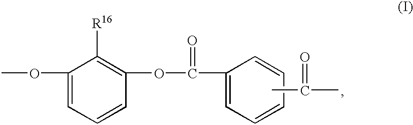

wherein R¹⁶ is hydrogen or C₁₋₄ alkyl, optionally in combination with structural units of the formula II:

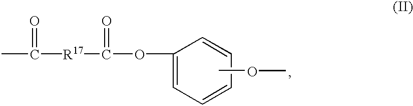

wherein R¹⁷ is a divalent C₄₋₁₂ aliphatic, alicyclic or mixed aliphatic-alicyclic radical. The latter polyesters may be prepared by the reaction of a 1,3-dihydroxybenzene moiety with at least one aromatic dicarboxylic acid chloride under alkaline conditions. Structural units of formula II contain a 1,3-dihydroxybenzene moiety which may be substituted with halogen, usually chlorine or bromine, or preferably with C₁₋₄ alkyl; e.g., methyl, ethyl, isopropyl, propyl, butyl. Said alkyl groups are preferably primary or secondary groups, with methyl being more preferred, and are most often located in the ortho position to both oxygen atoms although other positions are also contemplated. The most preferred moieties are resorcinol moieties, in which R¹⁶ is hydrogen. Said 1,3-dihydroxybenzene moieties are linked to aromatic dicarboxylic acid moieties which may be monocyclic moieties, e.g., isophthalate or terephthalate, or polycyclic moieties, e.g., naphthalenedicarboxylate.

In the optional soft block units of formula II, resorcinol or alkylresorcinol moieties are again present in ester-forming combination with R¹⁷ which is a divalent C₄₋₁₂ aliphatic, alicyclic or mixed aliphatic-alicyclic radical.

Polycarbonates useful in the compositions of the present invention include those comprising structural units of the formula III:

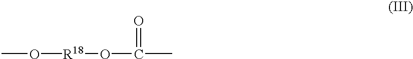

wherein at least about 60 percent of the total number of R¹⁸ groups are aromatic organic radicals and the balance thereof are aliphatic, alicyclic, or aromatic radicals. Suitable R¹⁸ radicals include m-phenylene, p-phenylene, 4,4′-biphenylene, 4,4′-bi(3,5-dimethyl)-phenylene, 2,2-bis(4-phenylene)propane, 6,6′-(3,3,3′,3′-tetramethyl-1,1′-spirobi [1H-indane]), 1,1′-bis(4-phenylene)-3,3,5-trimethylcyclohexane, and similar radicals such as those which correspond to the dihydroxy-substituted aromatic hydrocarbons disclosed by name or formula (generic or specific) in U.S. Pat. No. 4,217,438.

More preferably, R¹⁸ is an aromatic organic radical and still more preferably a radical of the formula IV:

—A¹—Y¹—A²—

wherein each A¹ and A² is a monocyclic divalent aryl radical and Y¹ is a bridging radical in which one or two atoms separate A¹ and A². For example, A¹ and A² typically represent unsubstituted phenylene or substituted derivatives thereof. The bridging radical Y¹ is most often a hydrocarbon group and particularly a saturated group such as methylene; cyclohexylidene; 3,3,5-trimethylcyclohexylidene; or isopropylidene. The most preferred polycarbonates are bisphenol A polycarbonates, in which each of A¹ and A² is p-phenylene and y¹ is isopropylidene. Suitable polycarbonates may be made using any process known in the art, including interfacial, solution, solid state, or melt processes.

In one embodiment, the present invention comprises storage media wherein at least one layer contains at least one polycarbonate. In another embodiment, the present invention comprises storage media wherein at least one layer contains two different polycarbonates. Homopolycarbonates derived from a single dihydroxy compound monomer and copolycarbonates derived from more than one dihydroxy compound monomer are encompassed.

In one embodiment of the present invention, the polymers of the present invention comprises a polycarbonate or copolycarbonate comprising structural units (V) or (VI):

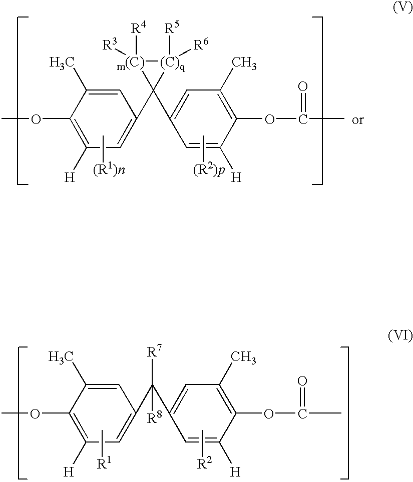

where R¹, R², R³, R⁴, R⁵, and R⁶ are independently selected from the group consisting of C₁-C₆ alkyl and hydrogen;

R⁷ and R⁸ are independently selected from the group consisting of C₁-C₆ alkyl, phenyl, C₁-C₆ alkyl substituted phenyl, or hydrogen;

m is an integer in a range between about 0 and about 12;

q is an integer in a range between about 0 and about 12;

m+q is an integer in a range between about 4 and about 12;

n is an integer in a range between about 1 and about 2; and

p is an integer in a range between about 1 and about 2.

Representative units of structure (V) include, but are not limited, to residues of 1,1-bis(4-hydroxy-3-methylphenyl)cyclohexane (DMBPC); 1,1-bis(4-hydroxy-3-methylphenyl)cyclopentane; 1,1-bis(4-hydroxy-3-methylphenyl)cycloheptane; 1,1-bis(4-hydroxy-3-methylphenyl)-3,3,5-trimethylcyclohexane (DMBPI); and mixtures thereof.

Representative units of structure (VI) include, but are not limited, to residues of 2,2-bis(4-hydroxy-3-methyl)propane (DMBPA); and 4,4′-(1-phenylethylidene)bis(2-methylphenol) (DMbisAP).

In an even further embodiment of the present invention, the substrate comprises polycarbonate or copolycarbonate comprises structural units (VII):

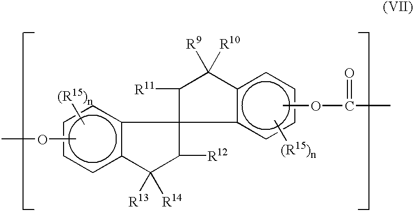

where R⁹, R¹⁰, R₁₃ and R¹⁴ are independently C₁-C₆ alkyl,

R¹¹ and R¹² are independently H or C₁-C₅ alkyl,

each R¹⁵ is independently selected from the group consisting of H and C₁-C₃ alkyl and each n is independently selected from the group consisting of 0, 1 and 2.

Representative units of structure (VII) include, but are not limited to, 6,6′-dihydroxy-3,3,3′,3′-tetramethyl spirobiindane (SBI); 6,6′-dihydroxy-3,3,5,3′,3′,5′-hexamethyl spirobiindane; 6,6′-dihydroxy-3,3,5,7,3′,3′,5′,7′-octamethylspirobiindane; 5,5′-diethyl-6,6′-dihydroxy 3,3,3′,3′-tetramethylspirobiindane, and mixtures thereof.

Illustrative, non-limiting examples of thermoset polymers include polymers derived from silicones, polyphenelene ethers, epoxys, cyanate esters, unsaturated polyesters, multifunctional allylic compounds such as diallylphthalate, acrylics, alkyds, phenol-formaldehyde, novolacs, resoles, bismaleimides, PMR resins, melamine-formaldehyde, urea-formaldehyde, benzocyclobutanes, hydroxymethylfurans, and isocyanates. In one embodiment of the present invention, the thermoset polymer further comprises at least one thermoplastic polymer, such as, but not limited to, polyphenylene ether, polyphenylene sulfide, polysulfone, polyetherimide, or polyester. The thermoplastic polymer is typically combined with a thermoset monomer mixture before curing of said thermoset.

The polyphenylene ethers in the present invention are known polymers comprising a plurality of structural units of the formula (VM)

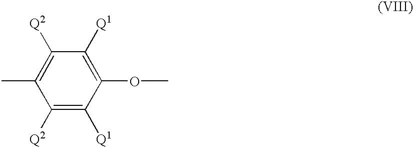

wherein in each of said units independently, each Q¹ is independently halogen, primary or secondary lower alkyl (i.e., alkyl containing up to 7 carbon atoms), phenyl, haloalkyl, aminoalkyl, hydrocarbonoxy, or halohydrocarbonoxy wherein at least two carbon atoms separate the halogen and oxygen atoms; and each Q² is independently hydrogen, halogen, primary or secondary lower alkyl, phenyl, haloalkyl, hydrocarbonoxy or halohydrocarbonoxy as defined for Q¹. Most often, each Q¹ is alkyl or phenyl, especially C₁₋₄ alkyl, and each Q² is hydrogen.

Both homopolymer and copolymer polyphenylene ethers are included in the present invention. Suitable copolymers include random copolymers containing such units in combination with (for example) 2,3,6-trimethyl-1,4-phenylene ether units. Also included in the present invention are polyphenylene ethers containing moieties prepared by grafting onto the polyphenylene ether in a known manner such materials as vinyl monomers or polymers such as polystyrenes and elastomers, as well as coupled polyphenylene ethers in which coupling agents such as low molecular weight polycarbonates, quinones, heterocycles and formals undergo reaction in known manner with the hydroxy groups of two polyphenylene ether chains to produce a higher molecular weight polymer, provided a substantial proportion of free OH groups remains.

Particularly useful polyphenylene ethers for many purposes are those which comprise molecules having at least one aminoalkyl-containing end group. The aminoalkyl radical is typically located in an ortho position to the hydroxy group. Polymers containing such end groups may be obtained by incorporating an appropriate primary or secondary monoamine such as di-n-butylamine or dimethylamine as one of the constituents of the oxidative coupling reaction mixture. Also frequently present are 4-hydroxybiphenyl end groups, typically obtained from reaction mixtures in which a by-product diphenoquinone is present, especially in a copper-halide-secondary or tertiary amine system. A substantial proportion of the polymer molecules, typically constituting as much as about 90% by weight of the polymer, may contain at least one of said aminoalkyl-containing and 4-hydroxybiphenyl end groups.

It will be apparent to those skilled in the art from the foregoing that the polyphenylene ethers contemplated for use in the present invention include all those presently known, irrespective of variations in structural units or ancillary chemical features. Both homopolymer and copolymer thermoplastic polymers are included in the compositions of the present invention. Copolymers may include random, block or graft type. Thus, for example, suitable polystyrenes include homopolymers, such as amorphous polystyrene and syndiotactic polystyrene, and copolymers containing these species. The latter embraces high impact polystyrene (HIPS), a genus of rubber-modified polystyrenes comprising blends and grafts wherein the rubber is a polybutadiene or a rubbery copolymer of styrene in a range between about 70% by weight and about 98% by weight and diene monomer in a range between about 2% by weight and about 30% by weight. Also included are ABS copolymers, which are typically grafts of styrene and acrylonitrile on a previously formed diene polymer backbone (e.g., polybutadiene or polyisoprene). Suitable ABS copolymers may be produced by any methods known in the art.

In order that those skilled in the art will be better able to practice the invention, the following examples are given by way of illustration and not by way of limitation. Efforts have been made to insure accuracy with respect to numbers (e.g., amounts, temperatures, etc.) but some error and deviations should be accounted for. Unless indicated otherwise, parts are by weight, temperature is in degrees Celsius (° C.) or is at room temperature and pressure is at or near atmospheric.

### EXAMPLE 1

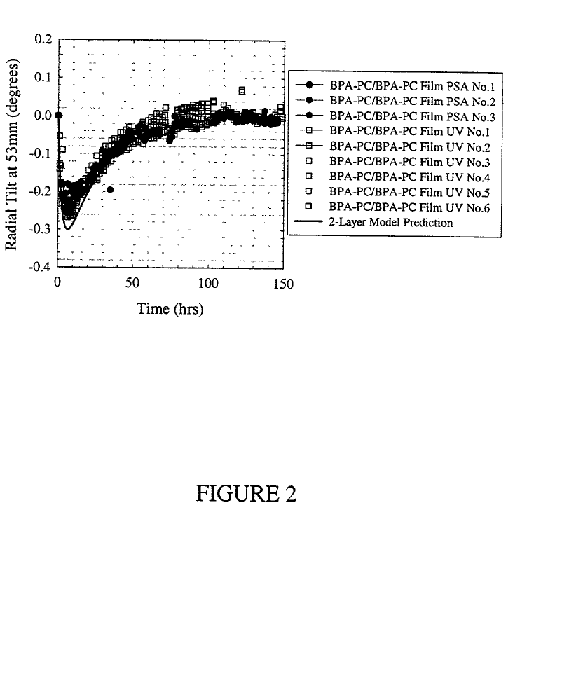

A series of structures were constructed from 2,2-bis(4-hydroxyphenyl)propane (BPA) for both film and substrate and then subjected to a humidity step of 40% at 25° C. All systems were nominally a 80 micron film adhered to a 1.15 mm substrate giving a thickness ratio of 0.070. The saturated water strain of the BPA homopolycarbonate (BPA-PC) was 0.00048. The swell of a polymeric material as defined herein is the percentage of volume growth of the totally dry material when subjected to a 100% relative humidity environment at a specific temperature. The swell was measured utilizing a TMA 2940 Thermomechanical Analyser from TA instruments. A film was mounted under a very low constant load and initially held in a dry atmosphere. The length change was then measured upon adsorption of water when the material was exposed to 100% relative humidity. The water strain or swell was taken to be the strain of the material (length change/original gauge length) FIG. 2 shows the change in radial tilt at 53mm for a BPA-PC substrate with a BPA-PC film. The laminate model with a substrate layer and a thin film layer gave a good fit to the experimental data. Additionally, the differing adhesive had little impact on the results. The mean maximum tilt performance was 0.25-0.26 degrees which equated to a tilt range of 0.50-0.52 degrees. This agreed well with the values for a material with such a swell coefficient.

### EXAMPLE 2

Several polymeric materials were constructed having a thickness ratio of 0.089 (98 micron film on a 1.1 millimeter substrate). Table 1 shows the results of the water strain at a step humidity change of 40% at 25° C. These are predictions of tilt and a measurement of strain. “PS” is polystyrene; “PPO/PS” is a blend of polyphenylene oxide and polystyrene; “BPA” is bisphenol A or 2,2-bis(4-hydroxyphenyl)propane; “BHPM” is bis(4-hydroxyphenyl)menthane; “DMBPA” is 2,2-bis(4-hydroxy-3-methyl)propane; “DMBPC” is ,1-bis(4-hydroxy-3-methylphenyl)cyclohexane; “SBI” is 6,6′-dihydroxy-3,3,3′,3′-tetramethylspirobiindane; and “DDDA” is dodecandioic acid.

TABLE 1

| | | | Max. | |
|---|---|---|---|---|
| | | | Radial | |
| | | Disk Max. | Tilt at | Max. Radial |
| | ε_{sat. 25° C.} = βs | Curvature | 53 mm | Tilt Range at |
| Material | (%) | (1/mm) | (deg.) | 53 mm (deg) |
| PS | 0.001 | 1.71 × 10⁻⁶ | 0.0052 | 0.0104 |
| PPO/PS | 0.008 | 1.37 × 10⁻⁵ | 0.0416 | 0.0832 |
| (39%/61%) | | | | |
| Disecbutyl-BPA | 0.013 | 2.22 × 10⁻⁵ | 0.0676 | 0.1352 |
| BHPM | 0.029 | 4.96 × 10⁻⁵ | 0.1507 | 0.3014 |
| BPA/Disecbutyl- | 0.032 | 5.48 × 10⁻⁵ | 0.1663 | 0.3326 |
| BPA (90/10) | | | | |
| SBI | 0.035 | 5.99 × 10⁻⁵ | 0.1818 | 0.3636 |
| DMBPA | 0.035 | 5.99 × 10⁻⁵ | 0.1818 | 0.3636 |
| DMBPC | 0.038 | 6.50 × 10⁻⁵ | 0.1975 | 0.3950 |
| BPA/DDDA | 0.041 | 7.02 × 10⁻⁵ | 0.2131 | 0.4262 |
| BPA | 0.048 | 8.21 × 10⁻⁵ | 0.2494 | 0.4988 |

Results in Table 1 demonstrate the materials tested fall within the water strain for storage media with a specified thickness ratio, radius, and change in relative humidity.

While typical embodiments have been set forth for the purpose of illustration, the foregoing descriptions should not be deemed to be a limitation on the scope of the present invention. Accordingly, various modifications, adaptations, and alternatives may occur to one skilled in the art without departing from the spirit and scope of the present invention.

1. A storage medium for data comprising a plurality of layers comprising:
a) a substrate layer comprising a polymer; and
b) at least one data layer on the substrate;
wherein the polymer at a predetermined maximum tilt range for the storage medium has a water strain determined by the following equation (I):
$$Water Strain ( \% ) < \frac{Max Radial Tilt Range ( degrees ) \cdot t \cdot π}{3.46 Δ rh \cdot r .}$$
wherein t is substrate thickness; r is a predetermined radius of the storage medium; and Δrh is change in relative humidity.

2. The storage medium in accordance with claim 1, wherein the radius is 53 millimeters.

3. The storage medium in accordance with claim 1, wherein the change in relative humidity is 40% at 25° C.

4. The storage medium in accordance with claim 1, wherein the polymer comprises a thermoplastic or a thermoset.

5. The storage medium in accordance with claim 4, wherein the polymer comprises at least one thermoplastic.

6. The storage medium in accordance with claim 5, wherein the thermoplastic is selected from the group consisting of polyesters, polycarbonates, polystyrenes, polymethylmethacrylates, polyketones, polyamides, aromatic polyethers such as polyether sulfones and polyether imides, polyether ketones, polyetherether ketones, polyphenylene ether, polyphenylene sulfides, and combinations thereof.

7. The storage medium in accordance with claim 6, wherein the thermoplastic comprises a polycarbonate.

8. The storage medium in accordance with claim 1, wherein the substrate thickness is in a range between about 0.4 millimeters and about 2.5 millimeters.

9. The storage medium in accordance with claim 8, wherein the substrate thickness is 1.2 millimeters.

10. The storage medium in accordance with claim 9, wherein the maximum tilt range is 1.2 degrees and the maximum water strain is less than 0.06%.

11. The storage medium in accordance with claim 9, wherein the maximum tilt range is 0.8 degrees and the maximum water strain is less than 0.04%.

12. The storage medium in accordance with claim 9, wherein the maximum tilt range is 0.3 degrees and the maximum water strain is less than 0.015%.

13. The storage medium in accordance with claim 8, wherein the substrate thickness is 0.6 millimeters.

14. The storage medium in accordance with claim 13, wherein the maximum tilt range is 1.2 degrees and the maximum water strain is less than 0.03%.

15. The storage medium in accordance with claim 13, wherein the maximum tilt range is 1.2 degrees and the maximum water strain is less than 0.02%.

16. The storage medium in accordance with claim 13, wherein the maximum tilt range is 1.2 degrees and the maximum water strain is less than 0.0008%.

17. A storage medium for data comprising a plurality of layers comprising:
a) a substrate layer comprising a polycarbonate; and
b) at least one data layer on the substrate;
wherein the polycarbonate at a maximum tilt range of 1.2 degrees has a water strain determined by the following equation (I):
$$Water Strain ( \% ) < \frac{Max Radial Tilt Range ( degrees ) \cdot t \cdot π}{3.46 Δ rh \cdot r .}$$
wherein t is 1.2 millimeters; r is a 53 millimeters; and Δrh is 40% at 25° C.

18. A storage medium for data comprising a plurality of layers comprising:
a) a substrate layer comprising a polycarbonate; and
b) at least one data layer on the substrate;
wherein the polycarbonate at a maximum tilt range of 1.2 degrees has a water strain determined by the following equation (I):
$$Water Strain ( \% ) < \frac{Max Radial Tilt Range ( degrees ) \cdot t \cdot π}{3.46 Δ rh \cdot r .}$$
wherein t is 0.6 millimeters; r is a 53 millimeters; and Δrh is 40% at 25° C.

19. A storage medium for data comprising a plurality of layers comprising:
a) at least one substrate layer comprising a polymer,
b) at least one data layer on the substrate; and
c) at least one thin film layer on the data layer wherein the thin film layer comprises a material with substantially the same physical properties as the polymer; and
wherein the polymer at a predetermined maximum tilt range for the storage medium has a water strain determined by the following equation (II):
$$Water Strain ( \% ) < \frac{Max Radial Tilt Range ( degrees ) \cdot t \cdot π}{3.46 Δ rh \cdot r ( 11.474 {ρ}^{2} - 6.6 ρ + 0.99 )}$$
wherein t is substrate thickness; ρ is a predetermined thickness ratio of the thickness of the thin film layer to the thickness of the substrate layer; r is a predetermined radius of the storage medium; and Δrh is change in relative humidity.

20. The storage medium in accordance with claim 19, wherein the radius is 53 millimeters.

21. The storage medium in accordance with claim 19, wherein the thickness ratio is 0.068 and the substrate thickness is 1.1 millimeters.

22. The storage medium in accordance with claim 21, wherein the maximum tilt range is 1.2 degrees and the maximum water strain is less than 0.095%.

23. The storage medium in accordance with claim 21, wherein the maximum tilt range is 0.8 degrees and the maximum water strain is less than 0.064%

24. The storage medium in accordance with claim 21, wherein the maximum tilt range is 0.3 degrees and the maximum water strain is less than 0.024%.

25. The storage medium in accordance with claim 19, wherein the thickness ratio is 0.091 and the substrate thickness is 1.1 millimeters.

26. The storage medium in accordance with claim 25, wherein the maximum tilt range is 1.2 degrees and the maximum water strain is less than 0.117%.

27. The storage medium in accordance with claim 25, wherein the maximum tilt range is 0.8 degrees and the maximum water strain is less than 0.078%.

28. The storage medium in accordance with claim 25, wherein the maximum tilt range is 0.3 degrees and the maximum water strain is less than 0.029%.

29. The storage medium in accordance with claim 19, wherein the change in relative humidity is 40% at 25° C.

30. The storage medium in accordance with claim 19, wherein the polymer comprises a thermoplastic or a thermoset.

31. The storage medium in accordance with claim 30, wherein the polymer comprises at least one thermoplastic.

32. The storage medium in accordance with claim 31, wherein the thermoplastic is selected from the group consisting of polyesters, polycarbonates, polystyrenes, polymethylmethacrylates, polyketones, polyamides, aromatic polyethers such as polyether sulfones and polyether imides, polyether ketones, polyetherether ketones, polyphenylene ether, polyphenylene sulfides, and combinations thereof.

33. The storage medium in accordance with claim 32, wherein the thermoplastic comprises a polycarbonate.

34. The storage medium in accordance with claim 19, wherein the thin film layer has a thickness in a range between about 5% and about 25% of the substrate thickness.

35. The storage medium in accordance with claim 34, wherein the thin film layer has a thickness in a range between about 10% and about 20% of the substrate thickness.

36. A storage medium for data comprising a plurality of layers comprising:
a) at least one substrate layer comprising a polycarbonate,
b) at least one data layer on the substrate; and
c) at least one thin film layer on the data layer wherein the thin film layer comprises a material with substantially the same physical properties as the polycarbonate; and
wherein the polycarbonate at a maximum tilt range of 1.2 degrees has a water strain determined by the following equation (II):
$$Water Strain ( \% ) < \frac{Max Radial Tilt Range ( degrees ) \cdot t \cdot π}{3.46 Δ rh \cdot r ( 11.474 {ρ}^{2} - 6.6 ρ + 0.99 )}$$
wherein t is 1.1 millimeters; ρ is 0.068; r is 53 millimeters; and Δrh is 40% at 25° C.

37. A storage medium for data comprising a plurality of layers comprising:
a) at least one substrate layer comprising a polycarbonate,
b) at least one data layer on the substrate; and
c) at least one thin film layer on the data layer wherein the thin film layer comprises a material with substantially the same physical properties as the polycarbonate; and
wherein the polycarbonate at a maximum tilt range of 1.2 degrees has a water strain determined by the following equation (II):
$$Water Strain ( \% ) < \frac{Max Radial Tilt Range ( degrees ) \cdot t \cdot π}{3.46 Δ rh \cdot r ( 11.474 {ρ}^{2} - 6.6 ρ + 0.99 )}$$
wherein t is 1.1 millimeters; ρ is 0.091; r is 53 millimeters; and Δrh is 40% at25° C.

38. A method for determining the water strain of a multilayer article with water absorption from one side, the method comprising predetermining a maximum tilt range and radius for the article; and
calculating the water strain using the following equation (ID:
$$Water Strain ( \% ) < \frac{Max Radial Tilt Range ( degrees ) \cdot t \cdot π}{3.46 Δ rh \cdot r .}$$
wherein t is article thickness; r is the predetermined radius of the article; and Δrh is change in relative humidity.

39. The method in accordance with claim 38, wherein the article comprises a storage medium for data.

40. The method in accordance with claim 39, wherein the storage medium for data comprises:
a) a substrate layer comprising a polymer; and
b) at least one data layer.

41. The method in accordance with claim 40, wherein the radius is 53 millimeters.

42. The method in accordance with claim 38, wherein the change in relative humidity is 40% at 25° C.

43. The method in accordance with claim 40, wherein the polymer comprises a thermoplastic or a thermoset.

44. The method in accordance with claim 43, wherein the polymer comprises at least one thermoplastic.

45. The method in accordance with claim 44, wherein the thermoplastic is selected from the group consisting of polyesters, polycarbonates, polystyrenes, polymethylmethacrylates, polyketones, polyamides, aromatic polyethers such as polyether sulfones and polyether imides, polyether ketones, polyetherether ketones, polyphenylene ether, polyphenylene sulfides, and combinations thereof.

46. The method in accordance with claim 45, wherein the thermoplastic comprises a polycarbonate.

47. The method in accordance with claim 40, wherein the substrate thickness is in a range between about 0.4 millimeters and about 2.5 millimeters.

48. The method in accordance with claim 47, wherein the substrate thickness is 1.2 millimeters.

49. The method in accordance with claim 48, wherein the maximum tilt range is 1.2 degrees and the maximum water strain is less than 0.06%.

50. The method in accordance with claim 48, wherein the maximum tilt range is 0.8 degrees and the maximum water strain is less than 0.04%.

51. The method in accordance with claim 48, wherein the maximum tilt range is 0.3 degrees and the maximum water strain is less than 0.015%.

52. The method in accordance with claim 47, wherein the substrate thickness is 0.6 millimeters.

53. The method in accordance with claim 52, wherein the maximum tilt range is 1.2 degrees and the maximum water strain is less than 0.03%.

54. The method in accordance with claim 52, wherein the maximum tilt range is 1.2 degrees and the maximum water strain is less than 0.02%.

55. The method in accordance with claim 52, wherein the maximum tilt range is 1.2 degrees and the maximum water strain is less than 0.0008%.

56. A method for determining the water strain of a storage medium for data wherein the storage medium comprises
a) a substrate layer comprising the polymer; and
b) at least one data layer;
the method comprising calculating the water strain using the following equation (I):
$$Water Strain ( \% ) < \frac{Max Radial Tilt Range ( degrees ) \cdot t \cdot π}{3.46 Δ rh \cdot r .}$$
wherein maximum tilt range is 1.2 degrees; t is 1.2 millimeters; r is 53 millimeters; and Δrh is 40% at 25° C.

57. A method for determining the water strain of a storage medium for data wherein the storage medium comprises
a) a substrate layer comprising the polymer; and
b) at least one data layer;
the method comprising calculating the water strain using the following equation (I):
$$Water Strain ( \% ) < \frac{Max Radial Tilt Range ( degrees ) \cdot t \cdot π}{3.46 Δ rh \cdot r .}$$
wherein maximum tilt range is 1.2 degrees; t is 0.6 millimeters; r is 53 millimeters; and Δrh is 40% at 25° C.

58. A method for determining the water strain of a multilayer article with water absorption from more than one side, the method comprising predetermining a maximum tilt range and radius for the article; and
calculating the water strain using the following equation (II):
$$Water Strain ( \% ) < \frac{Max Radial Tilt Range ( degrees ) \cdot t \cdot π}{3.46 Δ rh \cdot r ( 11.474 {ρ}^{2} - 6.6 ρ + 0.99 )}$$
wherein t substrate thickness; ρ is a predetermined thickness ratio of the thickness of the thin film layer to the thickness of the substrate layer; r is a predetermined radius of the storage medium; and Δrh is change in relative humidity.

59. The method in accordance with claim 58, wherein the article comprises a storage medium for data.

60. The method in accordance with claim 59, wherein the storage medium for data comprises:
a) at least one substrate layer comprising a polymer;
b) at least one data layer on the substrate; and
c) at least one thin film layer on the data layer wherein the thin film layer comprises a material with substantially the same physical properties as the polymer.

61. The method in accordance with claim 60, wherein the radius is 53 millimeters.

62. The method in accordance with claim 60, wherein the thickness ratio is 0.068 and the substrate thickness is 1.1 millimeters.

63. The method in accordance with claim 62, wherein the maximum tilt range is 1.2 degrees and the maximum water strain is less than 0.095%.

64. The method in accordance with claim 62, wherein the maximum tilt range is 0.8 degrees and the maximum water strain is less than 0.064%.

65. The method in accordance with claim 62, wherein the maximum tilt range is 0.3 degrees and the maximum water strain is less than 0.024%.

66. The method in accordance with claim 60, wherein the thickness ratio is 0.091 and the substrate thickness is 1.1 millimeters.

67. The method in accordance with claim 66, wherein the maximum tilt range is 1.2 degrees and the maximum water strain is less than 0.117%.

68. The method in accordance with claim 66, wherein the maximum tilt range is 0.8 degrees and the maximum water strain is less than 0.078%.

69. The method in accordance with claim 66, wherein the maximum tilt range is 0.3 degrees and the maximum water strain is less than 0.029%.

70. The method in accordance with claim 58, wherein the change in relative humidity is 40% at 25° C.

71. The method in accordance with claim 60, wherein the polymer comprises a thermoplastic or a thermoset.

72. The method in accordance with claim 71, wherein the polymer comprises at least one thermoplastic.

73. The method in accordance with claim 72, wherein the thermoplastic is selected from the group consisting of polyesters, polycarbonates, polystyrenes, polymethylmethacrylates, polyketones, polyamides, aromatic polyethers such as polyether sulfones and polyether imides, polyether ketones, polyetherether ketones, polyphenylene ether, polyphenylene sulfides, and combinations thereof.

74. The method in accordance with claim 73, wherein the thermoplastic comprises a polycarbonate.

75. The method in accordance with claim 58, wherein the thin film layer has a thickness in a range between about 5% and about 25% of the substrate thickness.

76. The method in accordance with claim 75, wherein the thin film layer has a thickness in a range between about 10% and about 20% of the substrate thickness.

77. A method for determining the water strain of a storage medium for data, wherein the storage medium for data comprises:
a) at least one substrate layer comprising a polycarbonate;
b) at least one data layer on the substrate; and
c) at least one thin film layer on the data layer wherein the thin film layer comprises a material with substantially the same physical properties as the polycarbonate;
the method comprising calculating the water strain using the following equation (II):
$$Water Strain ( \% ) < \frac{Max Radial Tilt Range ( degrees ) \cdot t \cdot π}{3.46 Δ rh \cdot r ( 11.474 {ρ}^{2} - 6.6 ρ + 0.99 )}$$
wherein maximum tilt range is 1.2 degrees; t is 1.1 millimeters; ] is 0.068; r is 53 millimeters; and Δrh is 40% at 25° C.

78. A method for determining the water strain of a storage medium for data, wherein the storage medium for data comprises:
b) at least one substrate layer comprising a polycarbonate;
b) at least one data layer on the substrate; and
c) at least one thin film layer on the data layer wherein the thin film layer comprises a material with substantially the same physical properties as the polycarbonate;
the method comprising calculating the water strain using the following equation (I):
$$Water Strain ( \% ) < \frac{Max Radial Tilt Range ( degrees ) \cdot t \cdot π}{3.46 Δ rh \cdot r ( 11.474 {ρ}^{2} - 6.6 ρ + 0.99 )}$$
wherein maximum tilt range is 1.2 degrees; t is 1.1 millimeters; ρ is 0.091; r is 53 millimeters; and Δrh is 40% at 25° C.

79. A polymer for the use in a storage medium for data wherein the storage medium comprises
a) a substrate layer comprising the polymer; and
b) at least one data layer;
wherein the polymer at a predetermined maximum tilt range for the storage medium has a water strain determined by the following equation (I):
$$Water Strain ( \% ) < \frac{Max Radial Tilt Range ( degrees ) \cdot t \cdot π}{3.46 Δ rh \cdot r .}$$
wherein t is substrate thickness; r is a predetermined radius of the storage medium; and Δrh is change in relative humidity.

80. The polymer in accordance with claim 79, wherein the radius of the storage medium is 53 millimeters.

81. The polymer in accordance with claim 79, wherein the change in relative humidity is 40% at 25° C.

82. The polymer in accordance with claim 79, which comprises a thermoplastic or a thermoset.

83. The polymer in accordance with claim 82, which comprises at least one thermoplastic.

84. The polymer in accordance with claim 83, wherein the thermoplastic is selected from the group consisting of polyesters, polycarbonates, polystyrenes, polymethylmethacrylates, polyketones, polyamides, aromatic polyethers such as polyether sulfones and polyether imides, polyether ketones, polyetherether ketones, polyphenylene ether, polyphenylene sulfides, and combinations thereof.

85. The polymer in accordance with claim 84, wherein the thermoplastic comprises a polycarbonate.

86. The polymer in accordance with claim 79, wherein the substrate thickness is in a range between about 0.4 millimeters and about 2.5 millimeters.

87. The polymer in accordance with claim 86, wherein the substrate thickness is 1.2 millimeters.

88. The polymer in accordance with claim 87, wherein the maximum tilt range is 1.2 degrees and the maximum water strain is less than 0.06%.

89. The polymer in accordance with claim 87, wherein the maximum tilt range is 0.8 degrees and the maximum water strain is less than 0.04%.

90. The polymer in accordance with claim 87, wherein the maximum tilt range is 0.3 degrees and the maximum water strain is less than 0.015%.

91. The polymer in accordance with claim 86, wherein the substrate thickness is 0.6 millimeters.

92. The polymer in accordance with claim 91, wherein the maximum tilt range is 1.2 degrees and the maximum water strain is less than 0.03%.

93. The polymer in accordance with claim 91, wherein the maximum tilt range is 1.2 degrees and the maximum water strain is less than 0.02%.

94. The polymer in accordance with claim 91, wherein the maximum tilt range is 1.2 degrees and the maximum water strain is less than 0.0008%.

95. A polycarbonate for the use in a storage medium for data wherein the storage medium comprises
a) a substrate layer comprising the polycarbonate; and
b) at least one data layer;
wherein the polycarbonate at a maximum tilt range of 1.2 degrees has a water strain determined by the following equation (I):
$$Water Strain ( \% ) < \frac{Max Radial Tilt Range ( degrees ) \cdot t \cdot π}{3.46 Δ rh \cdot r .}$$
wherein t is 1.2 millimeters; r is a 53 millimeters; and Δrh is 40% at 25° C.

96. A polycarbonate for the use in a storage medium for data wherein the storage medium comprises
a) a substrate layer comprising the polycarbonate; and
b) at least one data layer;
wherein the polycarbonate at a maximum tilt range of 1.2 degrees has a water strain determined by the following equation (I):
$$Water Strain ( \% ) < \frac{Max Radial Tilt Range ( degrees ) \cdot t \cdot π}{3.46 Δ rh \cdot r .}$$
wherein t is 0.6 millimeters; r is a 53 millimeters; and Δrh is 40% at 25° C.

97. A polymer for the use in a storage medium for data wherein the storage medium comprises
a) at least one substrate layer comprising the polymer,
b) at least one data layer on the substrate; and
c) at least one thin film layer on the data layer wherein the thin film layer comprises a material with substantially the same physical properties as the polymer; and
wherein the polymer at a predetermined maximum tilt range for the storage medium has a water strain determined by the following equation (II):
$$Water Strain ( \% ) < \frac{Max Radial Tilt Range ( degrees ) \cdot t \cdot π}{3.46 Δ rh \cdot r ( 11.474 {ρ}^{2} - 6.6 ρ + 0.99 )}$$
wherein t is substrate thickness; ρ is a predetermined thickness ratio of the thickness of the thin film layer to the thickness of the substrate layer; r is a predetermined radius of the storage medium; and Δrh is change in relative humidity.

98. The polymer in accordance with claim 97, wherein the storage medium radius is 53 millimeters.

99. The polymer in accordance with claim 97, wherein the thickness ratio is 0.068 and the substrate thickness is 1.1 millimeters.

100. The polymer in accordance with claim 99, wherein the maximum tilt range is 1.2 degrees and the maximum water strain is less than 0.095%.

101. The polymer in accordance with claim 99, wherein the maximum tilt range is 0.8 degrees and the maximum water strain is less than 0.064%.

102. The polymer in accordance with claim 99, wherein the maximum tilt range is 0.3 degrees and the maximum water strain is less than 0.024%.

103. The polymer in accordance with claim 97, wherein the thickness ratio is 0.091 and the substrate thickness is 1.1 millimeters.

104. The polymer in accordance with claim 103, wherein the maximum tilt range is 1.2 degrees and the maximum water strain is less than 0.117%.

105. The polymer in accordance with claim 103, wherein the maximum tilt range is 0.8 degrees and the maximum water strain is less than 0.078%.

106. The polymer in accordance with claim 103, wherein the maximum tilt range is 0.3 degrees and the maximum water strain is less than 0.029%.

107. The polymer in accordance with claim 97, wherein the change in relative humidity is 40% at 25° C.

108. The polymer in accordance with claim 97, which comprises a thermoplastic or a thermoset.

109. The polymer in accordance with claim 108, which comprises at least one thermoplastic.

110. The polymer in accordance with claim 109, wherein the thermoplastic is selected from the group consisting of polyesters, polycarbonates, polystyrenes, polymethylmethacrylates, polyketones, polyamides, aromatic polyethers such as polyether sulfones and polyether imides, polyether ketones, polyetherether ketones, polyphenylene ether, polyphenylene sulfides, and combinations thereof.

111. The polymer in accordance with claim 110, wherein the thermoplastic comprises a polycarbonate.

112. The polymer in accordance with claim 97, wherein the thin film layer has a thickness in a range between about 5% and about 25% of the substrate thickness.

113. The polymer in accordance with claim 112, wherein the thin film layer has a thickness in a range between about 10% and about 20% of the substrate thickness.

114. A polycarbonate for the use in a storage medium for data wherein the storage medium comprises
a) at least one substrate layer comprising the polycarbonate,
b) at least one data layer on the substrate; and
c) at least one thin film layer on the data layer wherein the thin film layer comprises a material with substantially the same physical properties as the polycarbonate; and
wherein the polycarbonate at a maximum tilt range of 1.2 degrees has a water strain determined by the following equation (II):
$$Water Strain ( \% ) < \frac{Max Radial Tilt Range ( degrees ) \cdot t \cdot π}{3.46 Δ rh \cdot r ( 11.474 {ρ}^{2} - 6.6 ρ + 0.99 )}$$
wherein t is 1.1 millimeters; ρ is 0.068; r is 53 millimeters; and Δrh is 40% at 25° C.

115. A polycarbonate for the use in a storage medium for data wherein the storage medium comprises
a) at least one substrate layer comprising the polycarbonate,
b) at least one data layer on the substrate; and
c) at least one thin film layer on the data layer wherein the thin film layer comprises a material with substantially the same physical properties as the polycarbonate; and
wherein the polycarbonate at a maximum tilt range of 1.2 degrees has a water strain determined by the following equation (II):
$$Water Strain ( \% ) < \frac{Max Radial Tilt Range ( degrees ) \cdot t \cdot π}{3.46 Δ rh \cdot r ( 11.474 {ρ}^{2} - 6.6 ρ + 0.99 )}$$
wherein t is 1.1 millimeters; ρ is 0.091; r is 53 millimeters; and Δrh is 40% at 25° C.
